(19) United States
(12) Patent Application Publication
(10) Pub. No.: US 2018/0348545 A1
(43) Pub. Date: Dec. 6, 2018

(54) PROGRESSIVE LENS WITH COLOR GRADIENT

(71) Applicant: HON HAI PRECISION INDUSTRY CO., LTD., New Taipei (TW)

(72) Inventor: HSIU-WEN CHIEN, New Taipei (TW)

(21) Appl. No.: 15/702,867

(22) Filed: Sep. 13, 2017

(30) Foreign Application Priority Data
Jun. 5, 2017 (TW) 106118470

(51) Int. Cl. G02C 7/10; G02C 7/06

(52) U.S. Cl. CPC G02C 7/105; G02C 7/068

(57) ABSTRACT

A lens with a progressive color gradient includes at least one color layer. A color of the color layer gradually becomes lighter from top to bottom. The color layer is distributed into a dark zone, a transition zone, and a light zone. A transparency of the dark zone is from 0 to 10%. A transparency of the transition zone is from 10 to 30%. A transparency of the light zone is from 30 to 80%. A height of the progressive lens from top to bottom is H, a height of the dark zone is H1, a height of the transition zone is H2, and Height of the light zone is H3, where H, H1, H2, and H3 satisfy the following formulas: 0.2H≤H1≤0.5H, 0.15H≤H2≤0.2H, and 0.3H≤H3≤0.7H.

### CROSS-REFERENCE TO RELATED APPLICATIONS

This application claims priority to Taiwanese Patent Application No. 106118470 filed on Jun. 5, 2017, the contents of which are incorporated by reference herein.

### FIELD

The subject matter herein generally relates to progressive lens.

### BACKGROUND

A progressive lens is useful for people with presbyopia indoors but not outdoors.

### BRIEF DESCRIPTION OF THE DRAWINGS

Implementations of the present technology will now be described, by way of example only, with reference to the attached figures.

FIG. 1 is a cross-section view of the exemplary embodiment of a progressive lens with color gradient.

FIG. 2 shows a composite spherical surface of the progressive lens in FIG. 1.

FIG. 3 shows color zone distribution of the progressive lens of FIG. 1.

FIG. 4 is a cross-section view of another exemplary embodiment of a progressive lens with color gradient.

FIG. 5 shows a color zone distribution curve of the progressive lens of FIG. 1 in a coordinate system according to a first example, a horizontal coordinate shows transparency values, a vertical coordinate shows relative height values, wherein a total height of the progressive lens is set to be one.

FIG. 6 shows a color zone distribution curve of the progressive lens of FIG. 1 in a coordinate system according to a second example, a horizontal coordinate shows transparency values, a vertical coordinate shows relative height values, wherein a total height of the progressive lens is set to be one.

FIG. 7 shows a color zone distribution curve of the progressive lens of FIG. 1 in a coordinate system according to a third example, a horizontal coordinate shows transparency values, a vertical coordinate shows relative height values, wherein a total height of the progressive lens is set to be one.

FIG. 8 shows a color zone distribution curve of the progressive lens of FIG. 1 in a coordinate system according to a fourth example, a horizontal coordinate shows transparency values, a vertical coordinate shows relative height values, wherein a total height of the progressive lens is set to be one.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain sections have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

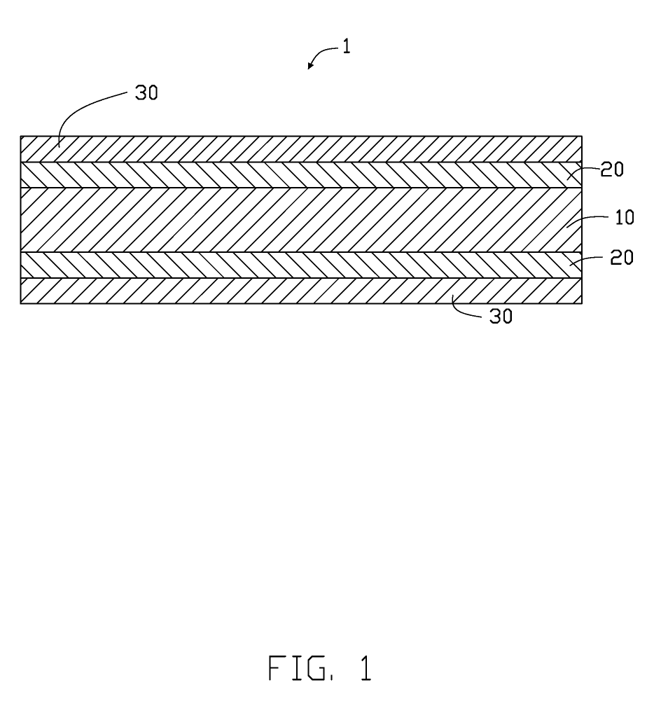

FIG. 1 illustrates a progressive lens 1 with color gradient in an exemplary embodiment. The progressive lens 1 includes a base layer 10, a color layer 20, and a rigid film 30.

The base layer 10 includes a front surface 101 and a back surface 102.

At least one of the front surface 101 and the back surface 102 is a progressive surface.

In this exemplary embodiment, the back surface 102 is a progressive surface.

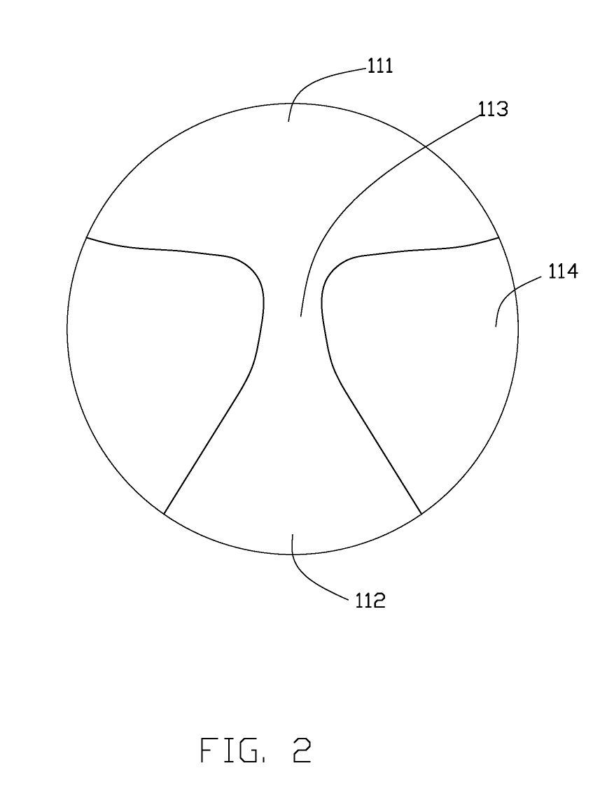

FIG. 2 illustrates the back surface 102. The back surface 102 includes a distance-vision zone 111, a near-vision zone 112, a corridor zone 113, and two mixed zones 114. The distance-vision zone 111 is distributed near top edge of the progressive lens 1. The near-vision zone 112 is distributed near the bottom edge of the progressive lens 1. The corridor zone 113 is distributed near a center portion of the progressive lens 1 and connects the distance-vision zone 111 and the near-vision zone 112. The two mixed zones 114 are separately distributed near side edges of the progressive lens 1 and also connect the distance-vision zone 111 and the near-vision zone 112. The distance-vision zone 111 has an optical power suitable for distance vision. The near-vision zone 112 has an optical power suitable for near vision. The corridor zone 113 has an optical power which varies from that of the distance-vision zone 111 to that of the near-vision zone 112.

The color layer 20 can be formed on the front surface 101, the back surface 102, or both.

In this exemplary embodiment, the color layer 20 is formed on both the front surface 101 and the back surface 102.

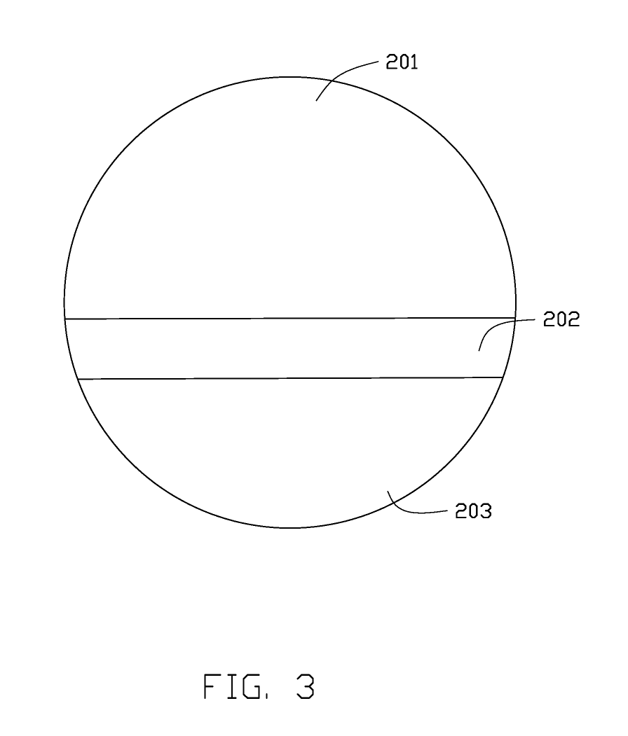

FIG. 3 illustrates that a color of the color layer 20 gradually becomes lighter from top to bottom, thus the color layer 20 can be distributed into a dark zone 201, a transition zone 202, and a light zone 203. A transparency of the dark zone 201 is from 0 to about 10%. A transparency of the transition zone 202 is from about 10 to about 30%. A transparency of the light zone 203 is from about 30 to about 80%.

A height of the progressive lens 1 from top to bottom is H, a height of the dark zone 201 is H1, a height of the transition zone 202 is H2, and a height of the light zone 203 is H3. H, H1, H2, and H3 satisfy the following formulas: 0.2H≤H1≤0.5H, 0.15H≤H2≤0.2H, 0.3H≤H3≤0.7H.

The progressive lens 1 can be useful under sunlight because of the color layer 20.

The rigid film 30 can be formed on a surface of the color layer 20 away from the base layer 10, and be formed on one side of the base layer 10 or on opposite sides of the base layer 10.

In this exemplary embodiment, the rigid film 30 is formed on surfaces of the color layer 20 away from the base layer 10, and is formed on opposite sides of the base layer 10.

The rigid film 30 protects the color layer 20 and supports the base layer 10.

The progressive lens 1 can further have an anti-reflective layer, an anti-fog layer, an anti-smear layer, or any combination thereof.

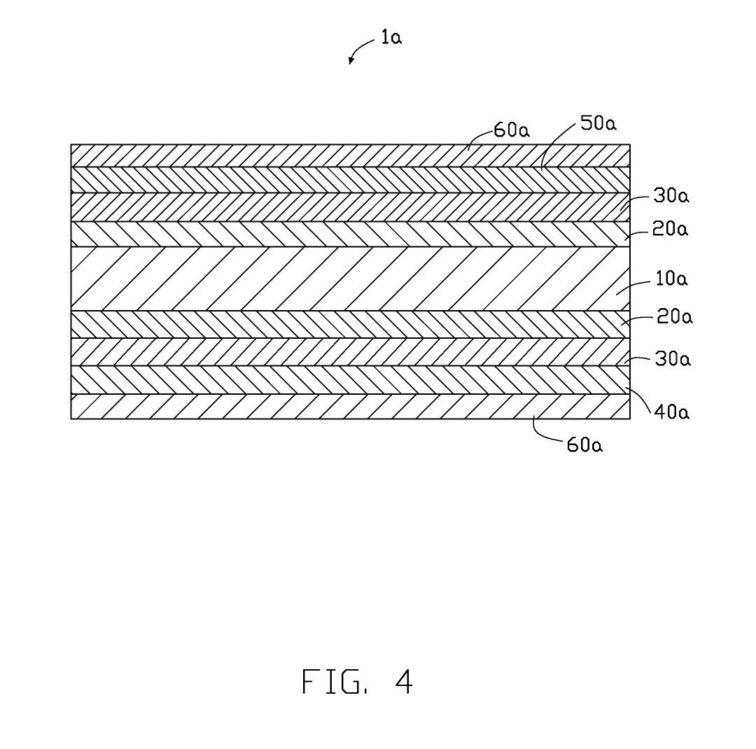

FIG. 4 illustrates a progressive lens 1a with color gradient in another exemplary embodiment. The progressive lens 1a includes a base layer 10a, a color layer 20a, a rigid film 30a, an anti-reflective layer 40a, an anti-fog layer 50a, and an anti-smear layer 60a.

In this exemplary embodiment, the color layer 20 is formed on both the front surface 101 and the back surface 102. The rigid film 30 is formed on surfaces of the color layer 20 away from the base layer 10, and is formed on opposite sides of the base layer 10. The anti-reflective layer 40a is formed on a surface of the rigid film 30a away from the base layer 10, and is formed on back surface side of the base layer 10. The anti-fog layer 50a is formed on a surface of the rigid film 30a away from the base layer 10, on front surface side of the base layer 10. The anti-smear layer 60a is formed on outer surfaces of the progressive lens 1a.

In other exemplary embodiments, the color layer 20a, the rigid film 30a, the anti-reflective layer 40a, the anti-fog layer 50a, and the anti-smear layer 60a can be in other distributions.

### Example 1

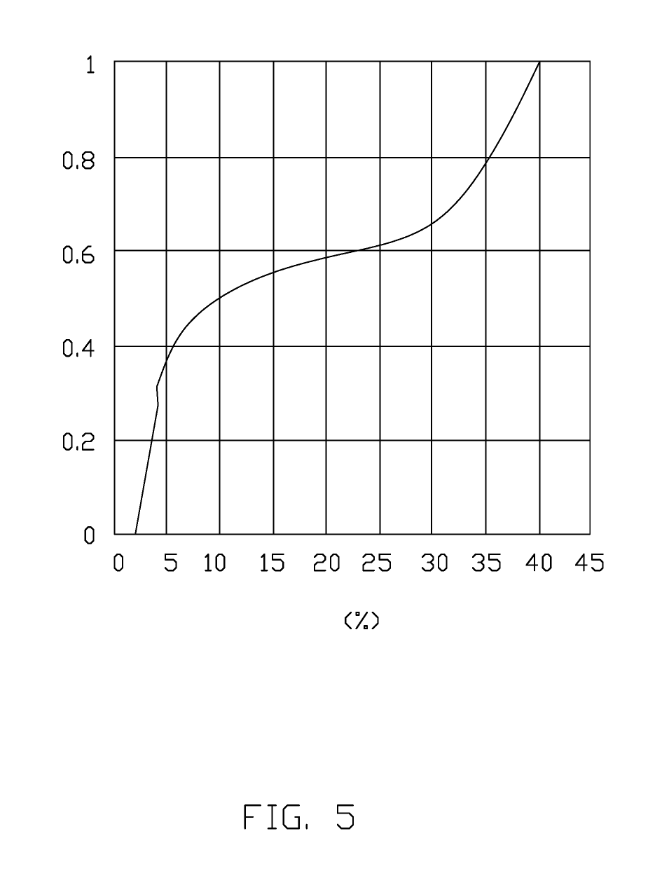

Progressive lens 1 with color gradient shown in FIGS. 1, 2, 3, and 5 includes a base layer 10, a color layer 20, and a rigid film 30. The base layer 10 includes a front surface 101 and a back surface 102. The back surface 102 is a progressive surface. The back surface 102 includes a distance-vision zone 111, a near-vision zone 112, a corridor zone 113, and two mixed zones 114. The distance-vision zone 111 is distributed near top edge of the progressive lens 1. The near-vision zone 112 is distributed near bottom edge of the progressive lens 1. The corridor zone 113 is distributed near center portion of the progressive lens 1 and connects the distance-vision zone 111 and the near-vision zone 112. The two mixed zones 114 are separately distributed near side edges of the progressive lens 1 and also connect the distance-vision zone 111 and the near-vision zone 112. The distance-vision zone 111 has optical power suitable for distance vision. The near-vision zone 112 has optical power suitable for near vision. The corridor zone 113 has optical power varying from that of the distance-vision zone 111 to that of the near-vision zone 112. The color layer 20 is formed on both the front surface 101 and the back surface 102. A color of the color layer 20 gradually becomes lighter from top to bottom. The color layer 20 is distributed into a dark zone 201, a transition zone 202, and a light zone 203. A transparency of the dark zone 201 is from 0 to about 10%. A transparency of the transition zone 202 is from about 10 to about 30%. A transparency of the light zone 203 is from about 30 to about 80%. A height of the progressive lens 1 from top to bottom is H, a height of the dark zone 201 is H1, a height of the transition zone 202 is H2, and a height of the light zone 203 is H3. H1 is about equal to 0.5H. H2 is about equal to 0.17H. H3 is about equal to 0.33H.

### Example 2

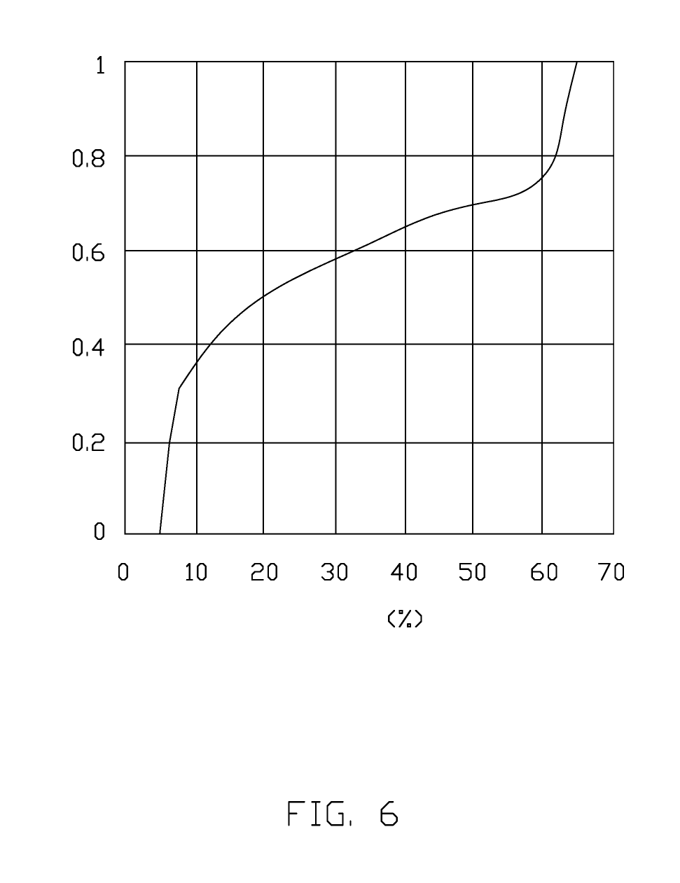

A progressive lens 1 with color gradient shown in FIGS. 1, 2, 3, and 6 includes a base layer 10, a color layer 20, and a rigid film 30. The base layer 10 includes a front surface 101 and a back surface 102. The back surface 102 is a progressive surface. The back surface 102 includes a distance-vision zone 111, a near-vision zone 112, a corridor zone 113, and two mixed zones 114. The distance-vision zone 111 is distributed near top edge of the progressive lens 1. The near-vision zone 112 is distributed near bottom edge of the progressive lens 1. The corridor zone 113 is distributed near center portion of the progressive lens 1 and connects the distance-vision zone 111 and the near-vision zone 112. The two mixed zones 114 are separately distributed near side edges of the progressive lens 1 and also connect the distance-vision zone 111 and the near-vision zone 112. The distance-vision zone 111 has optical power suitable for distance vision. The near-vision zone 112 has optical power suitable for near vision. The corridor zone 113 has optical power varying from that of the distance-vision zone 111 to that of the near-vision zone 112. The color layer 20 is formed on both the front surface 101 and the back surface 102. A color of the color layer 20 gradually becomes lighter from top to bottom. The color layer 20 is distributed into a dark zone 201, a transition zone 202, and a light zone 203. A transparency of the dark zone 201 is from 0 to about 10%. A transparency of the transition zone 202 is from about 10 to about 30%. A transparency of the light zone 203 is from about 30 to about 80%. A height of the progressive lens 1 from top to bottom is H, a height of the dark zone 201 is H1, a height of the transition zone 202 is H2, and a height of the light zone 203 is H3. H1 is about equal to 0.35H. H2 is about equal to 0.23H. H3 is about equal to 0.42H.

### Example 3

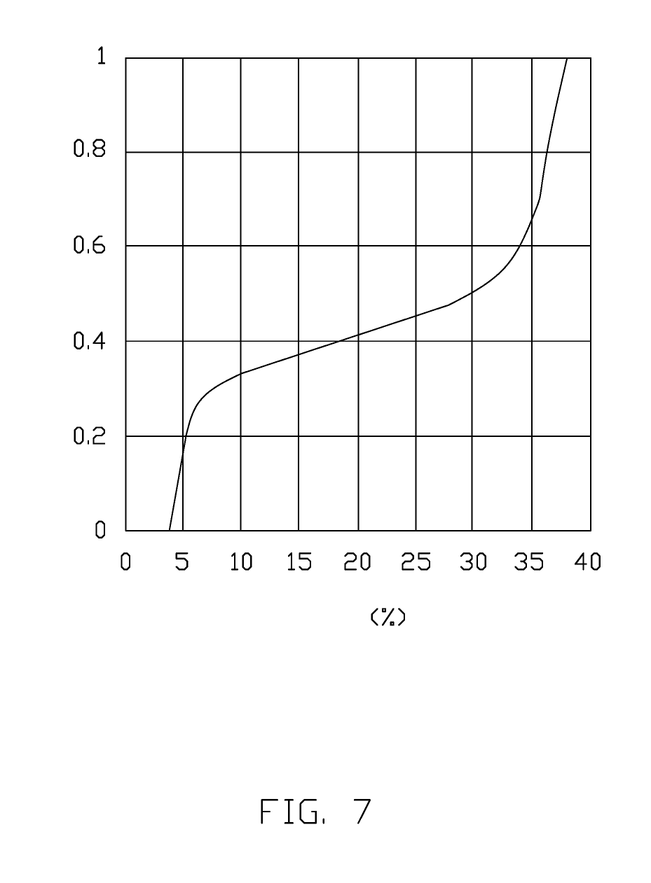

A progressive lens 1 with color gradient shown in FIGS. 1, 2, 3, and 7 includes a base layer 10, a color layer 20, and a rigid film 30. The base layer 10 includes a front surface 101 and a back surface 102. The back surface 102 is a progressive surface. The back surface 102 includes a distance-vision zone 111, a near-vision zone 112, a corridor zone 113, and two mixed zones 114. The distance-vision zone 111 is distributed near top edge of the progressive lens 1. The near-vision zone 112 is distributed near bottom edge of the progressive lens 1. The corridor zone 113 is distributed near center portion of the progressive lens 1 and connects the distance-vision zone 111 and the near-vision zone 112. The two mixed zones 114 are separately distributed near side edges of the progressive lens 1 and also connect the distance-vision zone 111 and the near-vision zone 112. The distance-vision zone 111 has optical power suitable for distance vision. The near-vision zone 112 has optical power suitable for near vision. The corridor zone 113 has optical power varying from that of the distance-vision zone 111 to that of the near-vision zone 112. The color layer 20 is formed on both the front surface 101 and the back surface 102. A color of the color layer 20 gradually becomes lighter from top to bottom. The color layer 20 is distributed into a dark zone 201, a transition zone 202, and a light zone 203. A transparency of the dark zone 201 is from 0 to about 10%. A transparency of the transition zone 202 is from about 10 to about 30%. A transparency of the light zone 203 is from about 30 to about 80%. A height of the progressive lens 1 from top to bottom is H, a height of the dark zone 201 is H1, a height of the transition zone 202 is H2, and a height of the light zone 203 is H3. H1 is about equal to 0.32H. H2 is about equal to 0.18H. H3 is about equal to 0.5H.

### Example 4

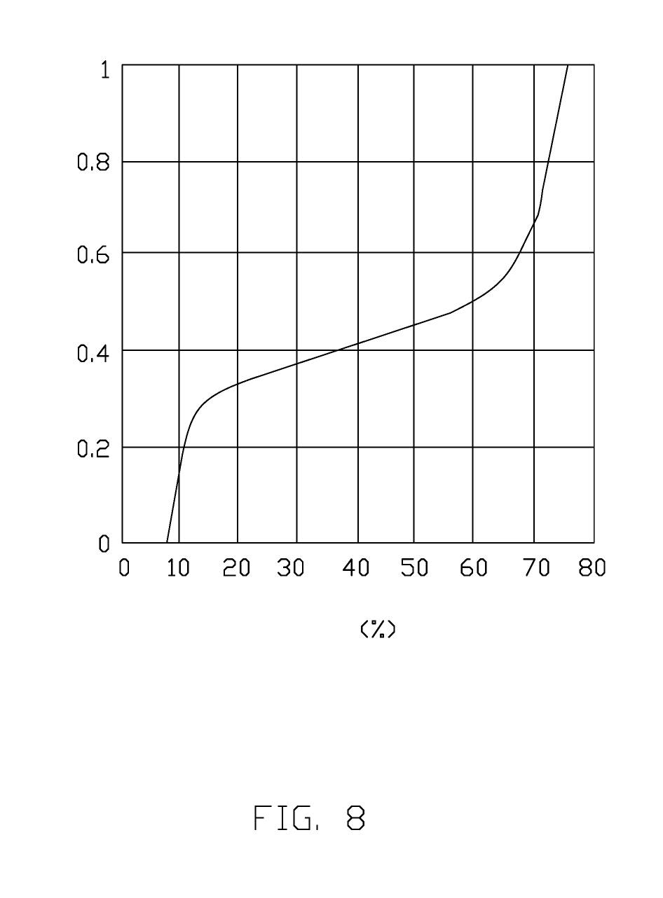

A progressive lens 1 with color gradient shown in FIGS. 1, 2, 3, and 8 includes a base layer 10, a color layer 20, and a rigid film 30. The base layer 10 includes a front surface 101 and a back surface 102. The back surface 102 is a progressive surface. The back surface 102 includes a distance-vision zone 111, a near-vision zone 112, a corridor zone 113, and two mixed zones 114. The distance-vision zone 111 is distributed near top edge of the progressive lens 1. The near-vision zone 112 is distributed near bottom edge of the progressive lens 1. The corridor zone 113 is distributed near center portion of the progressive lens 1 and connects the distance-vision zone 111 and the near-vision zone 112. The two mixed zones 114 are separately distributed near side edges of the progressive lens 1 and also connect the distance-vision zone 111 and the near-vision zone 112. The distance-vision zone 111 has optical power suitable for distance vision. The near-vision zone 112 has optical power suitable for near vision. The corridor zone 113 has optical power varying from that of the distance-vision zone 111 to that of the near-vision zone 112. The color layer 20 is formed on both the front surface 101 and the back surface 102. A color of the color layer 20 gradually becomes lighter from top to bottom. The color layer 20 is distributed into a dark zone 201, a transition zone 202, and a light zone 203. A transparency of the dark zone 201 is from 0 to about 10%. A transparency of the transition zone 202 is from about 10 to about 30%. A transparency of the light zone 203 is from about 30 to about 80%. A height of the progressive lens 1 from top to bottom is H, a height of the dark zone 201 is H1, a height of the transition zone 202 is H2, and a height of the light zone 203 is H3. H1 is about equal to 0.17H. H2 is about equal to 0.2H. H3 is about equal to 0.63H.

What is claimed is:

1. A progressive lens with color gradient, comprising:
a color layer;
wherein a color of the color layer gradually becomes lighter from top to bottom;
wherein the color layer is distributed into a dark zone, a transition zone, and a light zone, a transparency of the dark zone is from 0 to about 10%, a transparency of the transition zone is from about 10 to about 30%, a transparency of the light zone is from about 30 to about 80%;
wherein a height of the progressive lens from top to bottom is H, a height of the dark zone is H1, a height of the transition zone is H2, and a height of the light zone is H3;
wherein H, H1, H2, and H3 satisfy the following formulas: 0.2H≤H1≤0.5H, 0.15H≤H2≤0.2H, and 0.3H≤H3≤0.7H.

2. The progressive lens with color gradient of claim 1, further comprising a base layer, the base layer comprising a front surface and a back surface, the color layer being formed on the front surface, the back surface, or both.

3. The progressive lens with color gradient of claim 2, wherein the color layer is formed on both of the front surface and the back surface.

4. The progressive lens with color gradient of claim 2, wherein at least one of the front surface and the back surface is a progressive surface, the progressive surface comprises a distance-vision zone, a near-vision zone, a corridor zone; the distance-vision zone is distributed near top edge of the progressive lens, the near-vision zone is distributed near bottom edge of the progressive lens, the corridor zone is distributed near center portion of the progressive lens and connects the distance-vision zone and the near-vision zone.

5. The progressive lens with color gradient of claim 4, wherein the progressive surface further comprises two mixed zones, the two mixed zones are separately distributed near side edges of the progressive lens and also connect the distance-vision zone and the near-vision zone.

6. The progressive lens with color gradient of claim 4, wherein the back surface is the progressive surface.

7. The progressive lens with color gradient of claim 1, further comprising a rigid film, the rigid film being formed on a surface of the color layer.

8. The progressive lens with color gradient of claim 1, further comprising an anti-reflective layer, an anti-fog layer, an anti-smear layer or any combination thereof.

9. The progressive lens with color gradient of claim 1, wherein H1 is about equal to 0.5H, H2 is about equal to 0.17H, H3 is about equal to 0.33H.

10. The progressive lens with color gradient of claim 1, wherein H1 is about equal to 0.35H, H2 is about equal to 0.23H, H3 is about equal to 0.42H.

11. The progressive lens with color gradient of claim 1, wherein H1 is about equal to 0.32H, H2 is about equal to 0.18H, H3 is about equal to 0.5H.

12. The progressive lens with color gradient of claim 1, wherein H1 is about equal to 0.17H, H2 is about equal to 0.2H, H3 is about equal to 0.63H.
